(19) United States
(12) Patent Application Publication
(10) Pub. No.: US 2005/0073397 A1
(43) Pub. Date: Apr. 7, 2005

(54) Rear and front clearance light system for a vehicle

(75) Inventors: Beika Zheng, Round Rock, TX (US); Ying Chen, Round Rock, TX (US)

Correspondence Address: Beika ZHENG & Ying CHEN;Golden Tech International Inc, 8337 Lofty Lane, Round Rock, TX, 78681, US

(73) Assignee: Golden Tech International Inc, Round Rock, TX (US)

(21) Appl. No.: 10/678,895

(22) Filed: Oct. 3, 2003

(51) Int. Cl. B60Q 1/00

(52) U.S. Cl. 340/435; 340/436; 340/932.2

(57) ABSTRACT

The current invention gives novel methods for a driver to determine the vehicle extremity clearance. Two types of methods are disclosed: the blockage and the equidistance types. In the blockage type, the rear or front clearance is determined by observing the ground patterns projected by the light beams of which the paths extend beyond the vehicle's extremity. Should the vehicle approach too closely to an object, the light paths are blocked by the object so that the projected ground patterns disappear and thus the driver is alerted. In the equidistance type, an angle rule is disclosed. According to the rule, the distance between the two patterns projected by the divergent light beams on the object is made to be the same as the distance between the vehicle and the object. Therefore, a driver knows the vehicle extremity safety distance simply by estimating the distance between the two projected patterns.

### CROSS-REFERENCE TO RELATED APPLICATIONS

Cross-Reference to Related Applications

| | | | |
|---|---|---|---|
| 4214266 | July, 1980 | Myers. | 348/140 |
| 4240152 | December, 1980 | Duncan et al | 367/108 |
| 4277804 | July, 1981 | Robinson. | 348/148 |
| 4383238 | May, 1983 | Endo | 340/32 |
| 4528563 | July, 1985 | Takeuchi | 340/903 |
| 4626850 | December, 1986 | Chey | 340/903 |
| 4630904 | December, 1986 | Pastore | 362/494 |
| 4631516 | December, 1986 | Clinker. | 340/464 |
| 4891624 | January, 1990 | Ishikawa et al. | 340/436 |
| 4903004 | February, 1990 | Starke et al. | 340/425 |
| 4910591 | March, 1990 | Petrossian et al. | 348/148 |
| 4920520 | April, 1990 | Gobel et al. | 367/99 |
| 5027200 | June, 1991 | Petrossian et al. | 348/118 |
| 5028920 | July, 1991 | Dombrowski. | 340/904 |
| 5039217 | August, 1991 | Maekawa et al. | 340/942 |
| 5173881 | December, 1992 | Sindle | 367/101 |
| 5212467 | May, 1993 | Park | 340/435 |
| 5235316 | August, 1993 | Qualizza | 340/436 |
| 5281947 | January, 1994 | Durley et al. | 340/433 |
| 5289321 | February, 1994 | Secor. | 359/896 |
| 5303205 | April, 1994 | Gauthier et al. | 367/108 |
| 5307136 | April, 1994 | Saneyoshi. | 356/3.14 |
| 5315285 | May, 1994 | Nykerk. | 340/426.23 |
| 5339075 | August, 1994 | Abst et al. | 340/903 |
| 5389912 | February, 1995 | Arvin. | 340/435 |
| 5455557 | October, 1995 | Noll et al. | 340/431 |
| 5502432 | March, 1996 | Ohmamyuda et al. | 340/436 |
| 5528217 | June, 1996 | Adams | 340/435 |
| 5541891 | July, 1996 | Waldmann et al. | 367/99 |
| 5574426 | November, 1996 | Shisgal et al. | 340/435 |
| 5635922 | June, 1997 | Cho et al. | 340/903 |
| 5646614 | July, 1997 | Abersfelder et al. | 340/932 |
| 5670935 | September, 1997 | Schofield et al. | 340/461 |
| 5734336 | March, 1998 | Smithline. | 340/903 |
| 5754099 | May, 1998 | Nishimura et al. | 340/435 |
| 5754123 | May, 1998 | Nashif et al. | 340/903 |
| 5767793 | June, 1998 | Agravante et al. | 340/903 |
| 5786772 | July, 1998 | Schofield et al. | 340/903 |
| 6069558 | May, 2000 | Kershaw. | 340/435 |
| 6184782 | February, 2001 | Oda et al. | 340/435 |
| 6204754 | March, 2001 | Berstis | 340/435 |
| 6218960 | April, 2001 | Ishikawa et al. | 340/901 |
| 6259359 | July, 2001 | Fujinami et al. | 340/435 |
| 6291906 | September, 2001 | Marcus et al. | 307/10 |
| 6292111 | September, 2001 | Ishikawa et al. | 340/937 |
| 6360170 | March, 2002 | Ishikawa et al. | 701/300 |
| 6,446,998 | Sept., 2002 | Koenig, et al. | 280/432 |
| 6,534,884 | March, 2003 | Marcus, et al. | 307/10.1 |
| 6,550,949 | April, 2003 | Bauer, et al. | 362/545 |
| 6,552,656 | April, 2003 | Polidi, et al. | 340/436 |
| 6,606,027 | August, 2003 | Reeves, et al. | 340/436 |

### STATEMENT REGARDING FEDERALLY SPONSORED RESEARCH OR DEVELOPMENT

This research is not sponsored by Federal founding.

### REFERENCE TO SEQUENCE LISTING, A TABLE, OR A COMPUTER PROGRAM LISTING COMPACT DISK APPENDIX

No appendix

### BACKGROUND OF THE INVENTION

1. Field of the Invention

The present invention relates to the feature of a vehicle with which a driver can determine the vehicle front and rear clear distance. The method is through introducing an additional light system to the vehicle. The vehicle extremity safety distance is then determined by directly observing the changes of projected light patterns on the ground or on the approaching object.

2. Description of Related Art

Considerable efforts have been made in the past in order to assist a driver to determine the rear safety distance of the vehicle. It has been proposed to use various types of sensors to generate an early warning for driving safety. For example, U.S. Pat. No. 6,566,868 issued to Bartingale, et al discloses a sensor system that detects the approaching object by measuring the induced magnetic field signal change.

It has also been proposed to introduce a rearward camera system for enhancing the rear vision for the driver. For example, U.S. Pat. 6,550,949 issued to Bauer, et al discloses a combined camera and lamp assembly that displays the rearview for the driver.

These inventions are based on the indirect approach in the sense that they rely on another party either to do the actual measurement or to relay the view to a vehicle driver. Our current invention is, instead, based on the driver's direct observation.

Effort is also made in the direction of the direct observation. U.S. Pat. 6,204,754 issued to Berstis, et al that discloses a proximity indicating system for a vehicle. The intersection of two (or more) light beams, projected on the object, is used to provide a direct indication of the distance from the object. However, for an object behind which is smaller than the vehicle, the driver cannot see directly the projected patterns on the object, due to the obstruction of the vehicle itself. Therefore, in this case a rearview camera is still needed to relay the view to the driver. Furthermore, this method needs to adjust the convergent angle of the light beams for measuring the distance, using for example a preprogrammed stepping motor. Our methods resolve these difficulties.

### BRIEF SUMMARY OF THE INVENTION

Novel methods are invented for a driver to determine the vehicle extremity clearance directly. Two types of systems are developed: the blockage and equidistance types. In the blockage type, the vehicle extremity clearance is verified by observing the preservation of the illuminated ground patterns projected by the light beams of which the paths extend beyond the vehicle extremity. Should the vehicle become too close to the object, the light paths are obstructed by the object so that the projected ground patterns disappear and thus the driver is alerted for the object's proximity. In this setup, the driver can determine directly the rear safety distance even for a small object behind the vehicle. In the equidistance type, the angles of two divergent light beams are set according to the angle rule disclosed in the current patent such that the distance between two projected patterns on the object is made to be the same as the distance between the vehicle and the object. Therefore, by estimating the distance between the two projected illuminated patterns, the driver knows precisely the distance from the object.

### BRIEF DESCRIPTION OF THE SEVERAL VIEWS OF THE DRAWING

FIG. 1 is the rear/driver side view of an exemplary clearance light system of the blockage type. The light beams shoot from one side of the vehicle end onto the other side's ground, forming illuminated ground patterns, say lines, for a driver to determine the rear and front clearance of the vehicle. Each light beam is set to keep a required distance from the respective vehicle bumper.

FIG. 2 is the front/passenger side view of the system described in FIG. 1.

FIG. 3 is the top view of the system described in FIG. 1.

FIG. 4 is the rear/driver side view of an exemplary clearance light system of the blockage type with advance warning feature. The light beams for advance warning (dotted lines) are projected further away from the vehicle bumper.

FIG. 5 is the top view of the system described in FIG. 4.

FIG. 6 is a diagram for explaining the angle rule, Eq. (1). The distance between two projected patterns on the object is denoted by AB and the distance between the vehicle and the object by OE. The two divergent dotted lines (OA and OB) represent light beams. The plane on which the two light beams lie, plane OAB, is parallel to the ground and perpendicular to the reference plane, say the plane representing the vehicle front, which is the starting plane for measuring the distance from the object and is perpendicular to the ground. The inclination angles of two divergent light beams with respect to the reference are denoted respectively by θ₁ and θ₂.

FIG. 7 is a three dimensional diagram for explaining the angle rule, Eq. (1), with the projected patterns on the object being two parallel lines, AD and BC. The distance between two projected parallel lines on the object is represented either by AB or CD. The distance between the vehicle and the object is OE. The divergent dotted lines represent light beams. There are two spreading bands of light beams residing respectively on plane OAD and plane OBC, which are perpendicular to the XY plane. The reference plane, say representing the vehicle front, is denoted by the XZ plane. The object is represented by plane ABCD. The inclination angles θ₁ and θ₂ are redefined respectively as the angle between plane OAD and the XZ plane and the angle between plane OBC and the XZ plane.

FIG. 8 is an exemplary clearance light system of the equidistance type. Two beams are symmetric to the vehicle center and lie on a plane parallel to the ground. The angle between two divergent beams is about 53°, such that the distance between two projected patterns on the object becomes the same as the distance between the vehicle and the object.

FIG. 9 is the top view of FIG. 8.

FIG. 10 is the front/passenger side view of an exemplary front clearance light system, in which two equidistance type light sets are introduced respectively for vehicle front center horizontally and passenger corner vertically.

FIG. 11 is the front/passenger side view of an exemplary front clearance light system, in which the equidistance type light set is introduced vertically for vehicle front/passenger corner and the blockage type light set is installed to generate a ground pattern on the front/driver side.

### DETAILED DESCRIPTION OF THE INVENTION

The present invention is a novel clearance light system that assists a driver to determine the vehicle rear and front clearance. Two types of methods are developed: the blockage type and the equidistance type. In the blockage type, the preservation of a suitably projected ground patterns is used to indicate the vehicle extremity clearance. In the equidistance type, the angles of two divergent light beams are set according to the angle rule disclosed in current patent such that the distance between two projected patterns on the object is made to be the same as the distance between the vehicle and the object.

Unlike other designs which involve the use of cameras and sensors to relay the information to the driver, the current method allows the driver to verify the vehicle's extremity clearance through direct observation. Note that the method based on projecting two or more light beams on the object actually cannot make the projected patterns directly visible to a vehicle driver for a smaller object behind. Instead, the blockage method based on projecting the light beams on the ground, as we are disclosing, can handle this situation.

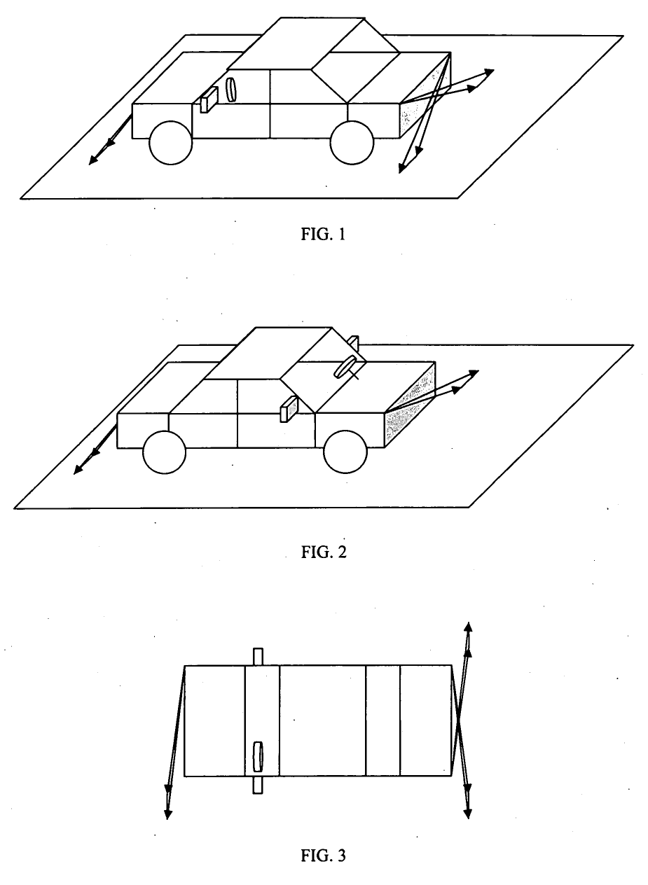

A typical blockage model of the rear clearance light system is shown in FIG. 1 and 3. Light beams emitted from each side of the rear end of the vehicle project the illuminated patterns, say lines parallel to the vehicle's rear bumper, onto the ground on the opposite side. The projected patterns extend beyond the vehicle's width such that the driver can observe them by looking back out the driver side window or using the side rearview mirrors. The paths of the light beams are designed to keep a required horizontal safety distance, for example a few inches, from the rear bumper. When backing up the vehicle, e.g., during parallel parking, the driver can determine the rear clearance by observing the preservation of the projected light patterns, say side lines; should an approaching object obstruct the light beams, the projected patterns would gradually disappear thus warning the driver of the object's proximity. Another practical use of the rear clearance light system is that a driver can use it to determine whether entire vehicle has entered the garage. Actually, in the simplest case setting up a projection on the driver side only is enough.

To make easier for a driver to observe the projected ground patterns on the rear, a simultaneous view angle adjustment can be implemented to the conventional side rearview mirrors. When the rear clearance light system is turned on, the mirrors are tilted down at the same time such that the driver can see the ground patterns through them.

Alternatively, additional mirrors can be added onto the existing ones to avoid the supplementary angle adjustments to the side rearview mirrors.

Since the rear clearance is usually needed to be checked during backing up a vehicle, the switch of the rear clearance lights can be tied to the vehicle's transmission. As soon as the vehicle is shifted to the reverse gear, the rear clearance lights are activated simultaneously.

As shown in FIG. 2, the same blockage method can be applied to the vehicle's front. It is however only practical to create a projection on the driver's side. The driver is hardly to see the front/passenger side ground pattern, although it may be an option.

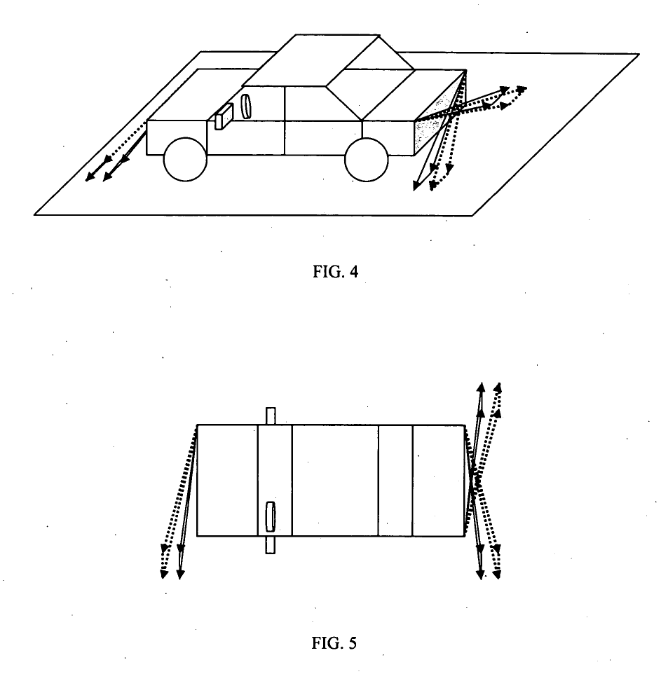

As shown in FIG. 4 and 5, the clearance light system is not limited to a single set of lights. In fact, multiple color coded ground patterns can be projected by several sets of light beams to create various stages of advance warning.

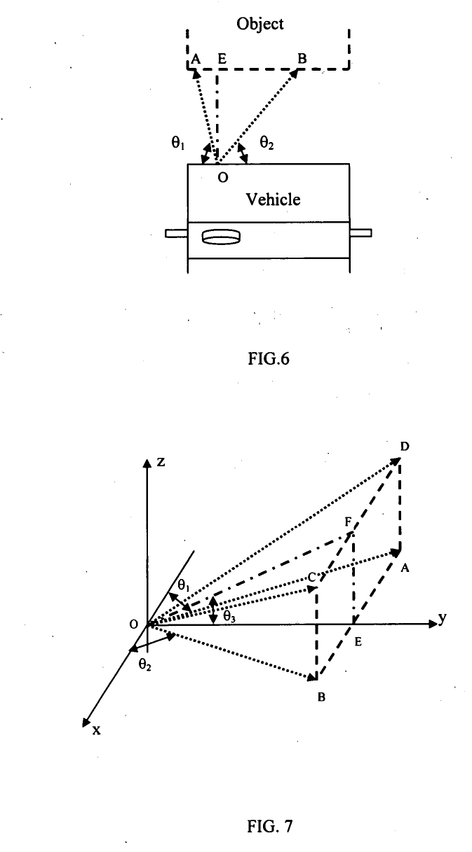

Next, we turn to explain the other type of extremity clearance light system: the equidistance type, which is particularly effective for the vehicle front. Let us first consider a simple exemplary case shown in FIG. 6 and discuss the general case later in FIG. 7. The plane representing the vehicle front is chosen as the reference plane in FIG. 6, which is perpendicular to the ground. The plane on which the two divergent light beams lie, plane OAB, is perpendicular to the reference plane. The two inclination angles, θ₁ and θ₂, with respect to the reference plane are set according to the following rule
cot(θ₁)+cot(θ₂)=AB/OE=1. (1)

Thus, the distance between the vehicle and the object, AB, is made to be the same as the distance between the two projected patterns, OE. In the case of symmetric setup, for example, the beam inclination angles should be as follows
θ₁=θ₂∓63.5°,
i.e., the divergent angle of the two beams is 180°−(θ₁+θ₂)≈53°.

Actually, the equidistance feature can be made in a more general situation with the projected patterns on the object being two parallel lines, AD and BC in FIG. 7. In this figure the XZ plane is chosen as the reference plane, which represents the starting plane for measuring the distance from the object and is perpendicular to the ground. The two light beams in FIG. 6 are replaced by two spreading bands of light beams in FIG. 7. The two bands of light beams reside respectively on plane OAD and plane OBC, which are perpendicular to the XY plane. This is equivalent to requiring that the intersection of plane OAD and plane OBC lies on the reference plane, the XZ plane. As soon as the two inclination angles θ₁ and θ₂ obey the angle rule in Eq. (1), the distance between two projected parallel lines, AB or CD, is equal to the distance between vehicle and the object, OE. Projecting two parallel lines on the object can enhance the visibility. Apparently, FIG. 6 is just an example of FIG. 7 with two parallel lines, AD and BC, merging respectively into two spots on the XY plane, A and B.

The equidistance method can be applied to measure the distance of an object behind the vehicle as well; however, it usually needs a third party, say a camera, to relay the view.

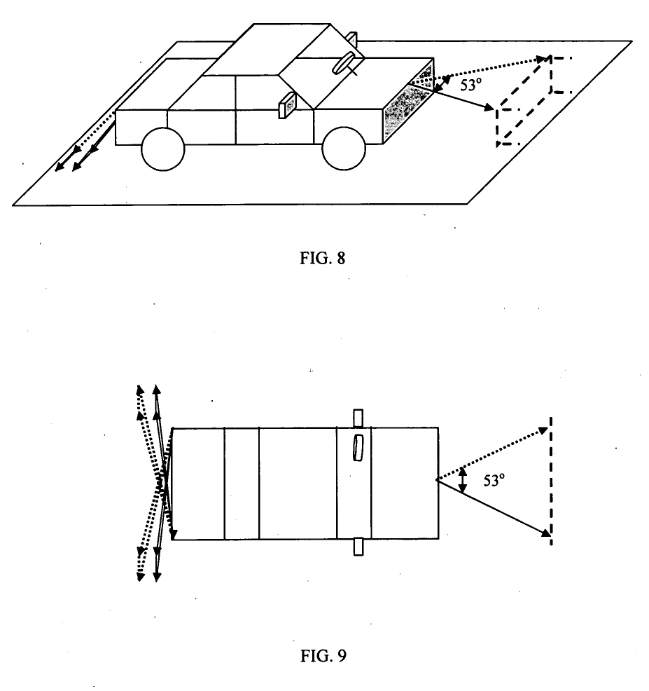

FIGS. 8 and 9 show the exemplary implementation of the front clearance light system of the equidistance type. Two symmetrically divergent line beams lie on a plane that is parallel to the ground. The divergent angle of the two symmetric light beams is about 53°. The light beams extend from the vehicle and form a “V”-like configuration at the vehicle front. When approaching an object, say another car, two illuminated patterns are projected on the object. Due to our novel beam angle design, the distance between two projected patterns is equal to the distance between the vehicle and the object. It is interesting to point out that this equality is independent of the distance from the object. Therefore, by observing the distance of two projected patterns, the driver knows the available safety distance before his vehicle.

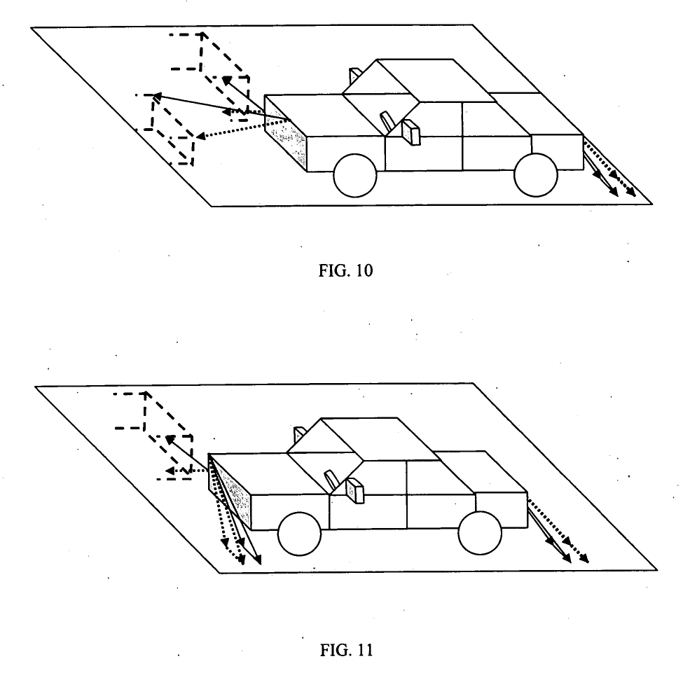

As shown in FIGS. 10 and 11, the clearance light system of equidistance type can be also applied to the front/passenger corner. This is particularly useful to avoid hitting or scratching another car when making a left turn parking for example. In this case, the plane on which two beams lie should be vertical to the ground in order to keep the ratio of the two projecting angles on the object unchanged in general. FIG. 10 shows an exemplary design of the front clearance light system of equidistance type with horizontal setting on the center and vertical setting at the front/passenger corner. FIG. 11 shows another exemplary front clearance light system. The blockage type setting is arranged to generate the ground pattern on the driver side and the equidistance type setting is applied to the front/passenger corner.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. For example, the light color, shape, installation positions on the vehicle, or number of lights can vary from one design to the other.

1. A method for providing an indication of the vehicle's extremity clearance
based on the projection of the ground patterns by light beams of which the paths are set beyond the vehicle's extremity,
say comprising:
a light set located at one side of the vehicle's end that projects its light beam, of which the path is set to keep a required safety distance beyond the vehicle bumper, onto the ground on the other side beyond the vehicle's width, forming an illuminated ground pattern, say a red line, which is made visible to the driver either by directly looking out the driver side window or using the side rearview mirrors.

2. The method as set forth in claim 1 and further comprising an advance warning light set, of which the light beams have a larger horizontal distance from the bumper and project additional ground patterns further beyond the vehicle's extremity.

3. The method as set forth in claims 1 and 2 being applied to generate the projected ground pattern on the vehicle rear/driver side.

4. The method as set forth in claim 1 and 2 being applied to generate the projected ground pattern on the vehicle rear/passenger side.

5. The method as set forth in claim 1 and 2 being applied to generate the projected ground pattern on the vehicle front/driver side.

6. The method as set forth in claim 1 and 2, when applied to the rear as set forth in claims 3 and 4, wherein the activation of the rear clearance lights simultaneously tilts the angle of the side rearview mirrors to the positions at which the driver can see the projected rear ground patterns through the mirrors.

7. The method as set forth in claim 1 and 2, when applied to the rear as set forth in claims 3 and 4, wherein additional mirrors are added to the side rearview mirrors respectively on the driver and passenger sides to assist the driver to observe the projected rear ground patterns.

8. The method as set forth in claim 1 and 2, when applied to the rear as set forth in claims 3 and 4, wherein the activation of the rear clearance lights is tied to the transmission such that, when the vehicle is shifted into the reverse gear, the rear clearance lights are turned on.

9. A method for indicating the distance of an approaching object from the vehicle, comprising:
two light sets located at the vehicle's front that shoot respectively two spreading bands of light beams which lie respectively on two divergent planes
of which the intersection resides on the reference plane which is the starting plane for measuring the distance from the object and is perpendicular to the ground,
and of which the inclination angles θ₁ and θ₂ with respect to the reference plane obeying (exactly or approximately) the rule cot(θ₁)+cot(θ₂)=1, such that the distance between the two illuminated lines projected on the object is made to be the same as the distance between the vehicle and the object.

10. The method as set forth in claim 9, wherein the two spreading bands of light beams are reduced to two individual light beams and consequently the two illuminated lines projected on the object merges into two illuminated spots.

11. The method as set forth in claim 10, being applied to the front/passenger side corner with divergent light beams residing on a plane which is perpendicular to the ground.
